(19) United States
(12) Patent Application Publication
(10) Pub. No.: US 2022/0339528 A1
(43) Pub. Date: Oct. 27, 2022

(54) BOARD AND COMPONENTS KIT

(71) Applicants: Brian M. Sarne, Camden, NJ (US); Heather A. Sarne, Camden, NJ (US)

(72) Inventors: Brian M. Sarne, Camden, NJ (US); Heather A. Sarne, Camden, NJ (US)

(21) Appl. No.: 17/862,430

(22) Filed: Jul. 12, 2022

Related U.S. Application Data
(63) Continuation of application No. 16/280,062, filed on Feb. 20, 2019.
(60) Provisional application No. 62/656,378, filed on Apr. 12, 2018.

(51) Int. Cl. A63F 3/00; A63F 11/00

(52) U.S. Cl. CPC A63F 3/00157; A63F 11/0074; A63F 2009/0482

(57) ABSTRACT

A board and components kit including a board with a wagering section and a numeric display section, and components including dice, and a marking chip is provided. The wagering section includes an ante area, a horns bonus area, a doubles bonus area, an under area, and an over area segregated and separately marked thereon for placing an ante and wagers by one or more players. The wagering section includes predefined rules and criteria for winning, losing, and placing wagers. The numeric display section is marked with numeric indicia. The marking chip indicates a numeric total on the numeric display section after each roll of the dice. One or more actions are performed for determining winners or losers based on a numeric total of numeric indicia on exposed faces of the dice rolled for a first time and on or more subsequent times respectively.

### CROSS-REFERENCE TO RELATED APPLICATIONS

This application is a continuation application of non-provisional patent application titled “Board and components kit”, application Ser. No. 16/280,062, filed in the United States Patent and Trademark Office on Feb. 20, 2019, which claims priority to and the benefit of the provisional patent application titled “Dice Roll Wagering Game”, application No. 62/656,378, filed in the United States Patent and Trademark Office on Apr. 12, 2018. The specifications of the above referenced patent applications are incorporated herein by reference in their entirety.

### BACKGROUND

A dice roll wagering game is one of the oldest forms of wagering and is based upon the probability for an occurrence of specific combinations of a numeric total of numeric indicia on exposed faces of a rolled pair of dice. Each dice comprises six faces with each face identified by a numeric indicium comprising 1, 2, 3, 4, 5, or 6. Therefore, there are thirty-six (36) possible combinations of numeric indicia that may appear during the roll of the pair of dice. The combinations of the numeric total of numeric indicia on exposed faces of the rolled dice comprises, for example, 2, 3, 4, 5, 6, 7, 8, 9, 10, 11 and 12. This statistical breakdown shows there are thirty-six combinations of numeric indicia that may appear in the rolled pair of dice and probabilities of the numeric total of numeric indicia on exposed faces of the rolled pair of dice for deciding winners or losers of the wagering game.

In general, a wagering board used for a dice roll wagering game consists of a wagering section and a numeric display section. The wagering section allows players participating in the wagering game to place a wager on a wagering option, for example, an ante area, based on a predefined criteria and predefined rules for winning/losing the wager placed on the wagering option, for example, the ante. Recent developments in wagering games allow players to place wagers on multiple wagering options on the wagering section of the wagering board. However, the existing wagering boards do not clearly and transparently display the predefined rules and predefined criteria for placing wagers on one or more of multiple wagering options.

Hence, there exists a long felt but unresolved need for providing a wagering board with separate sections for displaying each individual wagering option, displaying predefined rules, and displaying predefined criteria associated with each individual wagering option for each individual player, to allow the player to place the wager on each individual wager option transparently to the other players of the board game.

### SUMMARY OF THE INVENTION

This summary is provided to introduce a selection of concepts in a simplified form that are further disclosed in the detailed description of the invention. This summary is not intended to determine the scope of the claimed subject matter.

The board and components kit for an activity disclosed herein comprises a board and multiple components comprising a pair of dice, a dice cup, and a marking chip. The board comprises a wagering section and a numeric display section. The board disclosed herein addresses the above recited need for providing separate sections for each individual wagering option for each individual player, and for each predefined criteria associated with each individual wagering option. For this purpose, the wagering section of the board comprises an ante area, a horns bonus area, a doubles bonus area, an under area, and an over area segregated and separately marked on the wagering section of the board for placing an ante and wagers by one or more players of the activity.

The wagering section of the board further comprises predefined rules for winning a horns bonus area and a doubles bonus area, predefined rules for losing, and predefined criteria for placing the wagers, marked on the wagering section. The numeric display section of the board is marked with numeric indicia comprising numbers, for example, 4, 5, 6, 7, 8, 9, and 10. Each dice of the pair of dice comprises six faces numbered one to six. A dealer rolls the dice for a first time and one or more subsequent times. One or more first actions are performed in the activity based on a first numeric total of numeric indicia on exposed faces of the dice rolled for the first time. Furthermore, one or more second actions are performed in the activity based on a second numeric total of numeric indicia on exposed faces of the dice rolled for each of the subsequent times. The dice cup is used for shaking the dice. The marking chip indicates one of the numbers equal to a numeric total of numeric indicia on exposed faces of the rolled dice, on the numeric display section of the board after each roll of the dice.

### BRIEF DESCRIPTION OF THE DRAWINGS

The foregoing summary, as well as the following detailed description of the invention, is better understood when read in conjunction with the appended drawings. For illustrating the invention, exemplary constructions of the invention are shown in the drawings. However, the invention is not limited to the specific methods and components disclosed herein. The description of a method step or a component referenced by a numeral in a drawing is applicable to the description of that method step or component shown by that same numeral in any subsequent drawing herein.

FIG. 1A exemplarily illustrates game playing components of a board and components kit for an activity with one or more predefined rules for winning an ante, horns bonus, doubles bonus, and a predefined criteria for placing wagers, marked on the wagering section of the board.

FIG. 1B exemplarily illustrates an enlarged view of the predefined rules for winning the horns bonus and the doubles bonus for the activity shown in FIG. 1A.

FIG. 1C exemplarily illustrates an enlarged view of the predefined criteria for placing wagers, marked on the wagering section of the board shown in FIG. 1A.

FIGS. 2A-2D exemplarily illustrate a method for playing using a board and components kit for an activity based on outcomes of rolls of dice.

### DETAILED DESCRIPTION OF THE INVENTION

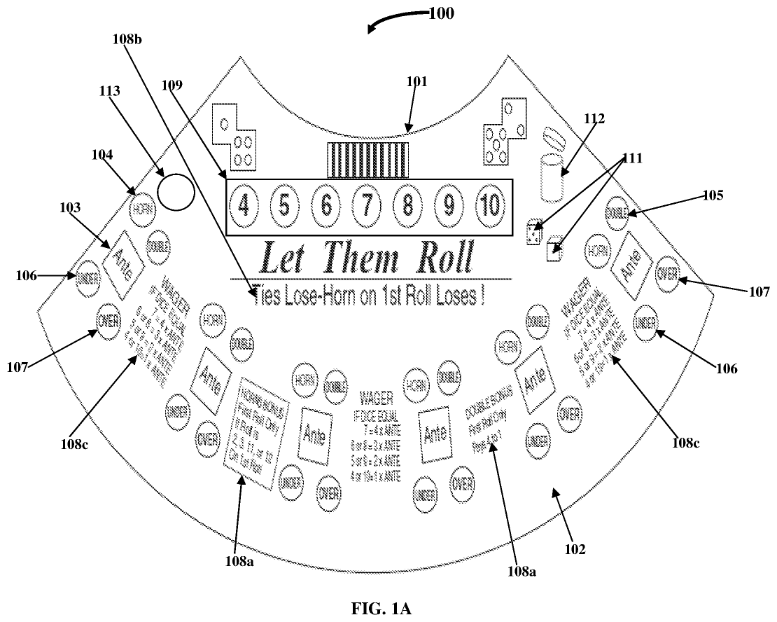

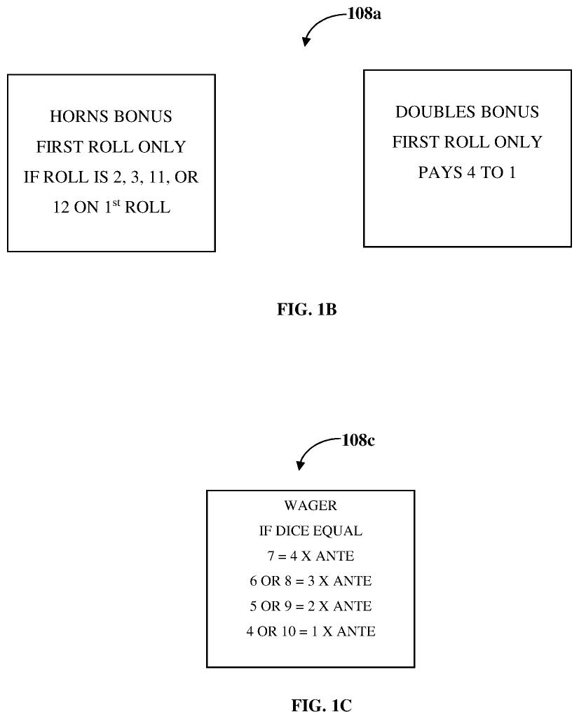

FIG. 1A exemplarily illustrates game playing components of a board and components kit 100 for an activity with one or more predefined rules for winning an ante, horns bonus, doubles bonus, and a predefined criteria for placing wagers, marked on the wagering section 102 of the board 101. The board and components kit 100 comprises a board 101, a pair of dice 111, a dice cup 112, and a marking chip 113. The board 101 comprises a wagering section 102 and a numeric display section 109. The wagering section 102 of the board 101 comprises an ante area 103, a horns bonus area 104, a doubles bonus area 105, an under area 106, and an over area 107 segregated and separately marked on the wagering section 102 for placing an ante and wagers by one or more players of the activity.

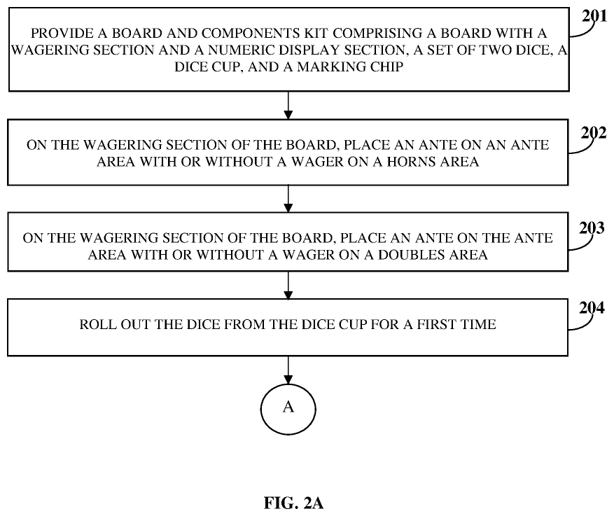

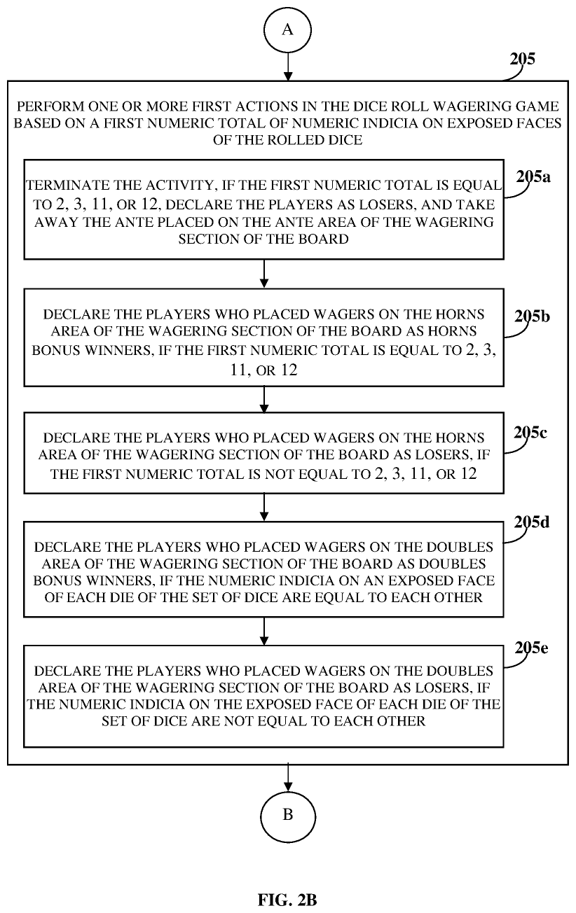

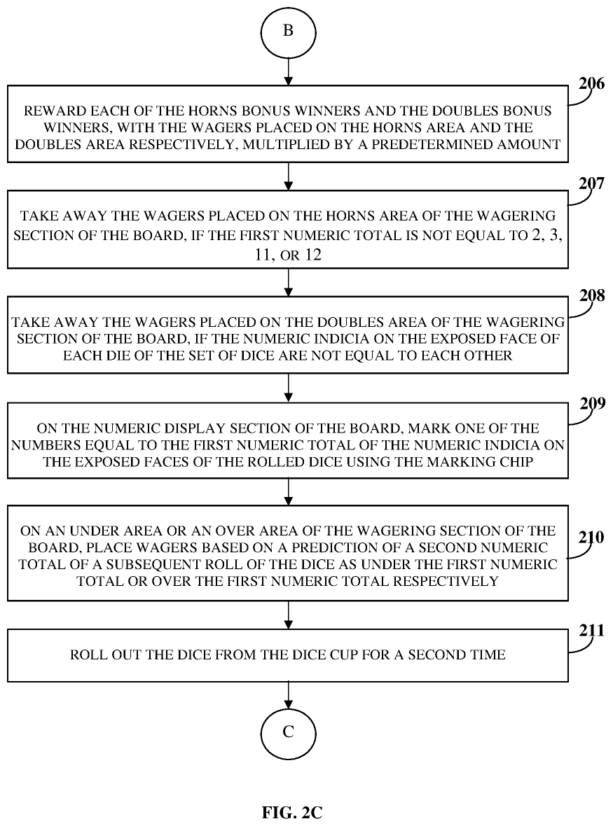

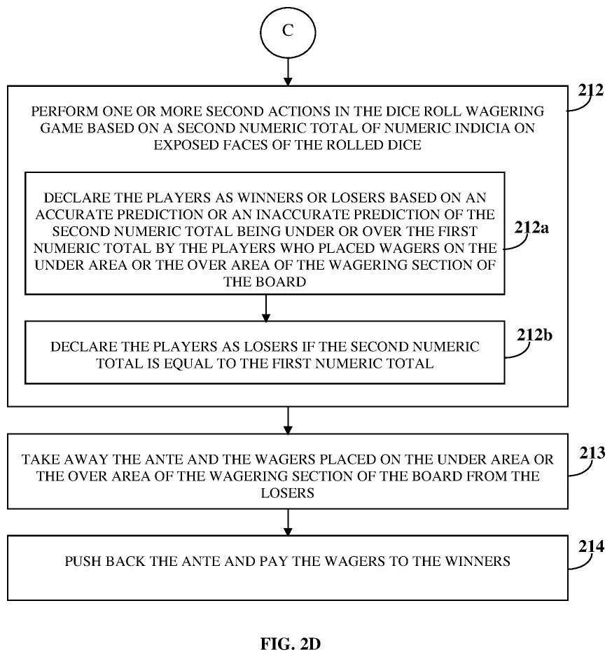

FIG. 1B exemplarily illustrates an enlarged view of the predefined rules 108a for winning the horns bonus and the doubles bonus for the activity shown in FIG. 1A. In an embodiment, a tie area is marked on the wagering section 102 of the board 101 of the board and components kit 100 for the activity. The wagering section 102 of the board 101 further comprises predefined rules 108a for winning a horns bonus and a doubles bonus, predefined rules 108b for losing, and predefined criteria 108c for placing the wagers disclosed in the detailed description of FIGS. 2A-2D, marked on the wagering section 102 of the board 101. An enlarged view showing predefined rules 108a for winning a horns bonus and a doubles bonus, marked on the wagering section 102 of the board 101 of the board and components kit 100 is exemplarily illustrated in FIG. 1B. The predefined rules 108b for losing comprises, for example, declaring the players as losers if a tie occurs; declaring the players as losers if any horns number on a first roll of the dice 111 occurs; etc. The horns number refers to a numeric total of numeric indicia on exposed faces of the rolled dice 111 equaling 2, 3, 11, or 12. FIG. 1C exemplarily illustrates an enlarged view showing predefined criteria 108c for placing wagers, marked on the under area 106 or the over area 107, marked on the wagering section 102 of the board 101 of the board and components kit 100 for a subsequent roll of the dice 111, as disclosed in the detailed description of FIGS. 2A-2D.

The numeric display section 109 of the board 101 is marked with numeric indicia 110 comprising numbers, for example, 4, 5, 6, 7, 8, 9, and 10 as exemplarily illustrated in FIG. 1A. Each die of the pair of dice 111 comprises six faces numbered one to six. A dealer rolls the dice 111 for a first time and one or more subsequent times. The dice cup 112 is used for shaking the dice 111. In an embodiment, the dice 111 are placed in a pop bubble and the dealer pushes the pop bubble to pop the dice 111 from the pop bubble. The pop bubble may be placed on any one corner of the board 101, for example, at the top of the board 101. The marking chip 113 indicates one of the numbers equal to a numeric total of numeric indicia on exposed faces of the rolled dice 111, on the numeric display section 109 of the board 101 after each roll of the dice 111, to allow players to keep track of the numeric total without confusion. One or more first actions are performed in the activity based on a first numeric total of numeric indicia on exposed faces of the dice 111 rolled for the first time as disclosed in the detailed description of FIGS. 2A-2D. Furthermore, one or more second actions are performed in the activity based on a second numeric total of numeric indicia on exposed faces of the dice 111 rolled for each of the subsequent times as disclosed in the detailed description of FIGS. 2A-2D. In an embodiment, as exemplarily illustrated in FIG. 1C, the predetermined criteria 108c for determining the amount of the wagers for the subsequent roll of the dice 111 comprises, for example, 4 times the placed ante, if the first numeric total equals 7; 3 times the placed ante, if the first numeric total equals 6 or 8, 2 times the placed ante, if the first numeric total equals 5 or 9; and 1 time the placed ante, if the first numeric total equals 4 or 10.

FIGS. 2A-2D exemplarily illustrate a method for playing an activity using a board and components kit 100 exemplarily illustrated in FIG. 1A, based on outcomes of a rolls of dice 111 exemplarily illustrated in FIG. 1A. The method disclosed herein, comprises providing 201 a board and components kit 100, the board and components kit 100 further comprises a board 101 with a wagering section 102 and a numeric display section 109, a pair of dice 111, a dice cup 112, and a marking chip 113 as exemplarily illustrated in FIG. 1A and as disclosed in the detailed description of FIG. 1A. For purposes of illustration, the detailed description refers to two players playing the activity; however, the scope of the activity 100 disclosed herein is not limited to two players but may be extended to the board game played by a single player or by more than two players.

In the method disclosed herein, on the wagering section 102 of the board 101, each player places 202 an ante on the ante area 103 exemplarily illustrated in FIGS. 1A-1B, with or without a wager on the horns bonus area 104 exemplarily illustrated in FIGS. 1A-1B. On the wagering section 102 of the board 101, each player places 203 an ante on the ante area 103 with or without a wager on the doubles bonus area 105 exemplarily illustrated in FIGS. 1A-1B. A dealer of the activity shakes the dice 111 in the dice cup 112 and rolls out 204 the dice 111 from the dice cup 112 for a first time. The dealer performs 205 one or more of multiple first actions in the activity based on a first numeric total of numeric indicia on exposed faces of the rolled dice 111. The first actions comprises terminating 205a placing furthers wagers in the activity, if the first numeric total is equal to 2, 3, 11, or 12, declaring the players as losers, and taking away the ante placed on the ante area 103 of the wagering section 102 of the board 101; declaring 205b the players who placed wagers on the horns bonus area 104 of the wagering section 102 of the board 101 as horns bonus winners, if the first numeric total is equal to 2, 3, 11, or 12; declaring 205c the players who placed wagers on the horns bonus area 104 of the wagering section 102 of the board 101 as losers, if the first numeric total is not equal to 2, 3, 11, or 12; declaring 205d the players who placed wagers on the doubles bonus area 105 of the wagering section 102 of the board 101 as doubles bonus winners, if the numeric indicia on the exposed face of each die of the pair of dice 111 are equal to each other; and declaring 205e the players who placed wagers on the doubles bonus area 105 of the wagering section 102 of the board 101 as losers, if the numeric indicia on the exposed face of each die of the pair of dice 111 are not equal to each other. The dealer declares horns bonus winners and doubles bonus winners on rolling out the dice 111 for the first time.

The dealer rewards 206 each of the horns bonus winners and the doubles bonus winners with the wagers placed on the horns bonus area 104 and the doubles bonus area 105 respectively, multiplied by a predetermined amount, for example, 4. The dealer takes away 207 the wagers placed on the horns bonus area 104 of the wagering section 102 of the board 101, if the first numeric total is not equal to 2, 3, 11, or 12. The dealer takes away 208 the wagers placed on the doubles bonus area 105 of the wagering section 102 of the board 101, if the numeric indicia on the exposed face of each die of the pair of dice 111 are not equal to each other. On the numeric display section 109 of the board 101, the dealer marks 209 one of the numbers equal to the first numeric total of the numeric indicia on the exposed faces of the rolled dice 111 using the marking chip 113.

On the under area 106 or the over area 107 of the wagering section 102 of the board 101 exemplarily illustrated in FIGS. 1A-1B, the players place 210 wagers based on a prediction of a second numeric total of a subsequent roll of the dice 111 as under the first numeric total or over the first numeric total respectively. The amount of the wagers is determined based on the predetermined criteria 108c marked on the wagering section 102 of the board 101 exemplarily illustrated in FIG. 1A. The predetermined criteria 108c for determining the amount of the wagers to be placed on the wagering section 102 of the board 101 for a subsequent roll of the dice 111 comprises 1, 2, 3, or 4 times the placed ante, if the first numeric total equals 7; 1, 2, or 3 times the placed ante, if the first numeric total equals 6 or 8; 1 or 2 times the placed ante, if the first numeric total equals 5 or 9; and 1 time the placed ante, if the first numeric total equals 4 or 10. In an embodiment as exemplarily illustrated in FIG. 1C, the predetermined criteria 108c for determining the amount of the wagers for the subsequent roll of the dice 111 comprises, for example, 4 times the placed ante, if the first numeric total equals 7; 3 times the placed ante, if the first numeric total equals 6 or 8; 2 times the placed ante, if the first numeric total equals 5 or 9; and 1 time the placed ante, if the first numeric total equals 4 or 10.

The dealer then shakes the dice 111 in the dice cup 112 and rolls out 211 the dice 111 from the dice cup 112 for a second time. The dealer performs 212 one or more of multiple second actions in the activity based on a second numeric total of numeric indicia on exposed faces of the rolled dice 111. The second actions comprise declaring 212a the players as winners or losers based on an accurate prediction or an inaccurate prediction of the second numeric total being under or over the first numeric total by the players who placed the wagers on the under area 106 or the over area 107 of the wagering section 102 of the board 101 respectively; and declaring 212b the players as losers if the second numeric total is equal to the first numeric total. The dealer takes away 213 the ante and the wagers placed on the under area 106 or the over area 107 of the wagering section 102 of the board 101 from the losers. The dealer pushes back 214 the ante and pays the respective wagers to the winners. In an embodiment, the players place wagers based on a prediction of a second numeric total of a subsequent roll of the dice 111 as equal to the first numeric total in the tie area and the players have an option of placing the wager on the under area 106, the over area 107, or the tie area.

Disclosed below are examples of playing the activity exemplarily illustrated in FIGS. 1A-1C.

### EXAMPLE 1

A player places an ante on the ante area 103 of the wagering section 102 of the board 101. A dealer places the pair of dice 111 in the dice cup 112, shakes the dice 111 in the dice cup 112, and then turns the dice cup 112 over on the board 101 to roll the dice 111 and reveal the numeric indicia on exposed faces of the rolled dice 111. The numeric indicia on the exposed faces of the rolled dice 111 are 2 and 4. The first numeric total of the numeric indicia on the exposed faces of the rolled dice 111 is 2+4=6. As the first numeric total of the numeric indicia on the exposed faces of the rolled dice 111 reveals no horns number, that is, 2, 3, 11, or 12, the activity continues. The dealer places the marking chip 113 on the number 6 corresponding to the first numeric total 6 on the numeric display section 109 of the board 101 to remind the player of the first numeric total. The player predicts whether a second dice roll combination, that is, an outcome of a second roll of the dice 111, could be under or over the first numeric total, that is, 6. The player decides to wager on the second dice roll combination being over 6 and places a wager on the over area 107 of the wagering section 102 of the board 101. The dealer places the dice 111 back in the dice cup 112, shakes the dice 111 in the dice cup 112, and turns the dice cup 112 over on the board 101 to roll the dice 111, and reveal the numeric indicia on the exposed faces of the rolled dice 111. The numeric indicia on the exposed faces of the rolled dice 111 are 4 and 5. The second numeric total of the numeric indicia on the exposed faces of the rolled dice 111 is 4+5=9. As 9 is higher than 6, the player wins the hand and the dealer declares the player as a winner. The dealer pays the winner the wager placed on the over area 107 of the wagering section 102 of the board 101 and pushes back the ante placed on the ante area 103 of the wagering section 102 of the board 101 to the winner.

### EXAMPLE 2

A player places an ante on the ante area 103 of the wagering section 102 of the board 101. A dealer places the pair of dice 111 in the dice cup 112, shakes the dice 111 in the dice cup 112, and turns the dice cup 112 over on the board 101 to roll the dice 111 and reveal the numeric indicia on exposed faces of the rolled dice 111. The numeric indicia on the exposed faces of the rolled dice 111 are 4 and 3. The first numeric total of the numeric indicia on the exposed faces of the rolled dice 111 is 4+3=7. The player predicts whether a second dice roll combination would be under or over the first numeric total, that is, 7. The player decides to wager on the second dice roll combination being under 7 and places a wager on the under area 106 of the wagering section 102 of the board 101. The dealer places the dice 111 back in the dice cup 112, shakes the dice 111 in the dice cup 112, and turns the dice cup 112 over on the board 101 to roll the dice 111 and reveal the numeric indicia on the exposed faces of the rolled dice 111. The numeric indicia on the exposed faces of the rolled dice 111 are 4 and 5. The second numeric total of the numeric indicia on the exposed faces of the rolled dice 111 is 4+5=9. The player loses since 9 is higher than 7. The dealer declares the player as a loser and takes away the wager placed on the under area 106 of the wagering section 102 of the board 101 and the ante placed on the ante area 103 of the wagering section 102 of the board 101.

### EXAMPLE 3

A player places an ante on the ante area 103 of the wagering section 102 of the board 101. A dealer places the pair of dice 111 in the dice cup 112, shakes the dice 111 in the dice cup 112, and turns the dice cup 112 over on the board 101 to roll the dice 111 and reveal the numeric indicia on the exposed faces of the rolled dice 111. The numeric indicia on the exposed faces of the rolled dice 111 are 2 and 3. The first numeric total of the numeric indicia on the exposed faces of the rolled dice 111 is 2+3=5. The player predicts whether a second dice roll combination would be under or over the first numeric total, that is, 5. The player decides to wager on the second dice roll combination being over 5 and places a wager on the over area 107 of the wagering section 102 of the board 101. The dealer places the dice 111 back in the dice cup 112, shakes the dice 111 in the dice cup 112, and turns the dice cup 112 over on the board 101 to roll the dice 111 and reveal the numeric indicia on the exposed faces of the rolled dice 111. The numeric indicia on the exposed faces of the rolled dice 111 are 3 and 2. The second numeric total of the numeric indicia on the exposed faces of the rolled dice 111 is 3+2=5. The player loses since the first numeric total and the second numeric total are equal, and a tie has occurred. As a tie occurred, the player loses in accordance with the rules 108b for losing in the activity marked on the board 101 exemplarily illustrated in FIG. 1A. The dealer declares the player as a loser based on the tie, and takes away the wager placed on the over area 107 of the wagering section 102 of the board 101 and the ante placed on the ante area 103 of the wagering section 102 of the board 101.

### EXAMPLE 4

Multiple players place their antes on the ante areas 103 of the wagering section 102 of the board 101. A dealer places the pair of dice 111 in the dice cup 112, shakes the dice 111 in the dice cup 112, and turns the dice cup 112 over on the board 101 to roll the dice 111 and reveal the numeric indicia on exposed faces of the rolled dice 111. The numeric indicia on the exposed faces of the rolled dice 111 are 6 and 5. The first numeric total of the numeric indicia on the exposed faces of the rolled dice 111 is 6+5=11. Based on the occurrence of a horns number on the first roll of the dice 111, all the players lose in accordance with the predefined rules 108b for losing in the activity marked on the board 101 exemplarily illustrated in FIG. 1A. The dealer declares the players as losers based on the occurrence of the horns number and takes away the ante placed on the ante area 103 of the wagering section 102 of the board 101.

### EXAMPLE 5

In an embodiment of the activity disclosed herein, a horns bonus wager can be made on the first roll of the dice 111 only and a horns bonus wager payout is, for example, 4 to 1 in accordance with the predefined rules 108a for winning the horns bonus marked on the board 101 as exemplarily illustrated in FIG. 1A and FIG. 1C. That is, if, on the first roll of the dice 111, a dealer rolls any dice combination equaling a horns number 2,3,11, or 12, a player who made the horns bonus wager wins. Consider an example where a player places an ante on the ante area 103 and a wager of, for example, $5 on the horns bonus area 104 of the wagering section 102 of the board 101. A dealer places the pair of dice 111 in the dice cup 112, shakes the dice 111 in the dice cup 112, and turns the dice cup 112 over on the board 101 to roll the dice 111 and reveal the numeric indicia on exposed faces of the rolled dice 111. If the first numeric total of numeric indicia on the exposed faces of the rolled dice 111 is 2, 3, 11, or 12, then the dealer declares the player who placed the wager on the a horns bonus area 104 of the wagering section 102 of the board 101 as a horns bonus winner and pays the horns bonus winner an amount equal to, for example, 4 times the wager the player placed on the horns bonus area 104. Consider an example where the numeric indicia on the exposed faces of the rolled dice 111 are 6 and 5. The first numeric total of the numeric indicia on the exposed faces of the rolled dice 111 is 6+5=11. The dealer declares the player who placed the wager on the horns bonus area 104 of the wagering section 102 of the board 101 as a horns bonus winner, pays the horns bonus winner a reward equal to, for example, 4 times $5 that is equal to $20, and pushes back the original wager, that is, the ante to the horns bonus winner.

### EXAMPLE 6

A player places an ante on the ante area 103 and a wager on the horns bonus area 104 of the wagering section 102 of the board 101. A dealer places the pair of dice 111 in the dice cup 112, shakes the dice 111 in the dice cup 112, and turns the dice cup 112 over on the board 101 to roll the dice 111 and reveal the numeric indicia on exposed faces of the rolled dice 111. The numeric indicia on the exposed faces of the rolled dice 111 are 4 and 2. The first numeric total of the numeric indicia on the exposed faces of the rolled dice 111 is 4+2=6. Since the first numeric total is not equal to 2, 3, 11 or 12, that is, the first numeric total is not a horns number, the dealer declares the player who placed the wager on the horns bonus area 104 of the wagering section 102 of the board 101 as a horns bonus loser and takes away the wager placed on the horns bonus area 104 of the wagering section 102 of the board 101; the dealer pays back the wager placed on the ante area 103 of the board 101 as the first numerical total is equal to the horns number.

### EXAMPLE 7

In an embodiment of the activity disclosed herein, a doubles bonus wager can be made on the first roll of the dice 111 only and a doubles bonus wager payout is, for example, 4 to 1 in accordance with the predefined rules 108a for winning the doubles bonus marked on the board 101, as exemplarily illustrated in FIG. 2B. A player places an ante on the ante area 103 and a wager on the doubles bonus area 105 of the wagering section 102 of the board 101. A dealer places the pair of dice 111 in the dice cup 112, shakes the dice 111 in the dice cup 112, and turns the dice cup 112 over on the board 101 to roll the dice 111 and reveal the numeric indicia on exposed faces of the rolled dice 111. The numeric indicia on the exposed faces of the rolled dice 111 are 5 and 5. The matching numeric indicia on the dice 111 are considered as doubles. The dealer declares the player who placed the wager on the doubles bonus area 105 of the wagering section 102 of the board 101 as a doubles bonus winner and pays the doubles bonus winner a reward equal to, for example, 4 times the wager placed on the doubles bonus area 105 of the wagering section 102 of the board 101, in accordance with the predefined rules 108a for winning the doubles bonus marked on the board 101 as exemplarily illustrated in FIGS. 2A-2B.

### EXAMPLE 8

A player places an ante on the ante area 103 and a wager on the doubles bonus area 105 of the wagering section 102 of the board 101. A dealer places the pair of dice 111 in the dice cup 112, shakes the dice 111 in the dice cup 112, and turns the dice cup 112 over on the board 101 to roll the dice 111 and reveal the numeric indicia on exposed faces of the rolled dice 111. The numeric indicia on the exposed faces of the rolled dice 111 are 2 and 5. Since the numeric indicia on the dice 111 do not match, there are no doubles. The dealer declares the player who placed the wager on the doubles bonus area 105 of the wagering section 102 of the board 101 as a doubles bonus loser and takes away the wager placed on the doubles bonus area 105 of the wagering section 102 of the board 101, however the dealer pays back the wager placed on the ante area 103 of the board 101 as the first numerical total is equal to the horns number.

### EXAMPLE 9

This example shows an outcome based on two players selecting different wagering methods. A first player and a second player place an ante, for example, $10 each to be in hand on their respective ante areas 103 of the wagering section 102 of the board 101. A dealer places the pair of dice 111 in the dice cup 112, shakes the dice 111 in the dice cup 112, and turns the dice cup 112 over on the board 101 to roll the dice 111 and reveal the numeric indicia on exposed faces of the rolled dice 111. The numeric indicia on the exposed faces of the rolled dice 111 are 4 and 2. The first numeric total of the numeric indicia on the exposed faces of the rolled dice 111 is 4+2=6. The first player places a wager of 3 times the placed ante, that is, $30, on the under area 106 of the wagering section 102 of the board 101 and the second player places a wager of 3 times the placed ante, that is, $30 on the over area 107 of the wagering section 102 of the board 101. The dealer places the dice 111 back in the dice cup 112, shakes the dice 111 in the dice cup 112, and turns the dice cup 112 over on the board 101 to roll the dice 111 and reveal the numeric indicia on the exposed faces of the rolled dice 111. The numeric indicia on the exposed faces of the rolled dice 111 are 5 and 5. The second numeric total of the numeric indicia on the exposed faces of the rolled dice 111 is 5+5=10. The first player loses and the second player wins since 10 is higher than 6. The dealer declares the first player as a loser and takes away the wager placed on the under area 106 of the wagering section 102 of the board 101 and the ante placed on the ante area 103 of the wagering section 102 of the board 101. The dealer declares the second player as a winner, pays $30 to the second player, that is, the wager placed on the over area 107 of the wagering section 102 of the board 101, and pushes back the ante placed on the ante area 103 of the wagering section 102 of the board 101 to the second player.

### EXAMPLE 10

A first player and a second player place an ante, for example, $10 on the respective ante area 103 of the wagering section 102 of the board 101 allocated for each player. The first player and the second player can play for bonuses such as a horns bonus and a doubles bonus in the activity. The first player places a wager of $5 on the horns bonus area 104 and a wager of $5 on the doubles bonus area 105 of the wagering section 102 of the board 101. The second player does not place wagers on the horns bonus area 104 and the doubles bonus area 105 of the wagering section 102 of the board 101. A dealer places the pair of dice 111 in the dice cup 112, shakes the dice 111 in the dice cup 112, and turns the dice cup 112 over on the board 101 to roll the dice 111 and reveal the numeric indicia on exposed faces of the rolled dice 111. The numeric indicia on the exposed faces of the rolled dice 111 are 1 and 1. The first numeric total of the numeric indicia on the exposed faces of the rolled dice 111 is 2. The first player loses the ante placed on the ante area 103 of the wagering section 102 due to the occurrence of a horns number on the first roll of the dice 111 in accordance with the predefined rules 108b for losing the activity marked on the board 101 exemplarily illustrated in FIG. 1A, but wins the horns wager and the doubles wager with, for example, a 4 to 1 payout for each. The dealer declares the first player as a horns bonus winner and a doubles bonus winner. The dealer pays the first player, for example, 4 times the wager placed on the horns bonus area 104, and 4 times the wager placed on the doubles bonus area 105 of the wagering section 102 of the board 101 in accordance with the predefined rules 108a for winning the activity marked on the board 101 exemplarily illustrated in FIG. 2A, and takes away the ante placed on the ante area 103 of the wagering section 102 of the board 101. The dealer declares the second player as a loser and takes away the ante placed on the ante area 103 of the wagering section 102 of the board 101 by the second player.

In an embodiment, the first player continues to roll the dice 111 until the first player loses the hand and then passes the dice 111 to the second player and the second player rolls the dice 111 until the second player loses the hand.

The board and components kit 100 disclosed herein is adopted for use in engaging in an activity, for example, a game. The game is played according to the rules described on the board 101. Therefore, a player playing the game is not required to remember the rules of the game. Furthermore, the board 101 provides separate sections, for example, a wagering section 102 and a numeric display section 109, for each individual wagering option for each individual player, and for each predefined criteria associated with each individual wagering option. The wagering section 102 of the board 101 comprises an ante area 103, a horns bonus area 104, a doubles bonus area 105, an under area 106, and an over area 107 segregated and separately marked on the wagering section 102 of the board 101 for placing an ante and wagers by the one or more players of the game which cannot be considered an abstract idea. The board 101 disclosed herein increases player convenience by providing separate sections (102 and 109) for each individual wagering option for each individual player, and for each predefined criteria associated with each individual wagering option. The board 101 disclosed herein also increases player convenience by describing rules of the game on the board 101.

The foregoing examples have been provided merely for explanation and are in no way to be construed as limiting of the board and components kit 100 for the activity disclosed herein. While the board and components kit 100 for the activity has been described with reference to various embodiments, it is understood that the words, which have been used herein, are words of description and illustration, rather than words of limitation. Furthermore, although the board and components kit 100 for the activity has been described herein with reference to particular means, materials, and embodiments, the board and components kit 100 for the activity is not intended to be limited to the particulars disclosed herein; rather, the board and components kit 100 for the activity extends to all functionally equivalent structures, methods and uses, such as are within the scope of the appended claims. While multiple embodiments are disclosed, it will be understood by those skilled in the art, having the benefit of the teachings of this specification, that the board and components kit 100 for the activity disclosed herein is capable of modifications and other embodiments may be effected and changes may be made thereto, without departing from the scope and spirit of the board and components kit 100 for the activity disclosed herein.

We claim:

1. A method for playing an activity using a board and components kit, comprising:
providing a board and components kit comprising a board with a wagering section and a numeric display section, a set of two dice, a dice cup, and a marking chip;
placing an ante on an ante area with or without a wager on a horns area, on the wagering section of the board;
placing an ante on the ante area with or without a wager on a doubles area, on the wagering section of the board;
rolling out the dice from the dice cup for a first time;
performing one or more first actions based on a first numeric total of numeric indicia on exposed faces of the rolled dice, comprising:
terminating the activity, if the first numeric total is equal to 2, 3, 11, or 12, declaring the players as losers, and taking away the ante placed on the ante area of the wagering section of the board;
declaring the players who placed wagers on the horns area of the wagering section of the board as horns bonus winners, if the first numeric total is equal to 2, 3, 11, or 12;
declaring the players who placed wagers on the horns area of the wagering section of the board as losers, if the first numeric total is not equal to 2, 3, 11, or 12;
declaring the players who placed wagers on the doubles area of the wagering section of the board as doubles bonus winners, if the numeric indicia on an exposed face of each die of the set of dice are equal to each other; and
declaring the players who placed wagers on the doubles area of the wagering section of the board as losers, if the numeric indicia on the exposed face of each die of the set of dice are not equal to each other;
rewarding each of the horns bonus winners and the doubles bonus winners, with the wagers placed on the horns area and the doubles area respectively, multiplied by a predetermined amount;
taking away the wagers placed on the horns area of the wagering section of the board, if the first numeric total is not equal to 2, 3, 11, or 12;
taking away the wagers placed on the doubles area of the wagering section of the board, if the numeric indicia on the exposed face of each die of the set of dice are not equal to each other;
placing the marking chip on one of the numbers on the numeric display section, only when the first numeric total is equal to numbers 4-10.
after placing the marking chip, placing wagers on an under area or an over area of the wagering section of the board, based on a prediction of a second numeric total of a subsequent roll of the dice as under the first numeric total or over the first numeric total respectively;
rolling out the dice from the dice cup for a second time;
performing one or more second actions based on a second numeric total of numeric indicia on exposed faces of the rolled dice, comprising:
declaring the players as winners or losers based on an accurate prediction or an inaccurate prediction by the players who placed wagers on the under area or the over area of the wagering section of the board, wherein the players predict the second numeric total as under or over the first numeric total;
declaring the players as losers if the second numeric total is equal to the first numeric total;
taking away the ante and the wagers placed on the under area or the over area of the wagering section of the board from the losers; and
pushing back the ante and pay the wagers to the winners.

2. The method of claim 1, wherein amount of the wagers placed on the under area or the over area of the wagering section of the board is determined based on a predetermined criteria marked on the wagering section of the board.

3. The method of claim 2, wherein the predefined criteria comprises:
4 multiplied by said placed ante, if said first numeric total equals 7;
3 multiplied by said placed ante, if said first numeric total equals one of 6 and 8;
2 multiplied by said placed ante, if said first numeric total equals one of 5 and 9; and
1 multiplied by said placed ante, if said first numeric total equals one of 4 and 10.

4. The method of claim 3, wherein the numeric display section only displays numbers 4-10 corresponding to the numbers covered by the predefined criteria.

5. The method of claim 1, wherein the dice are placed in a pop bubble and the dice are pushed out from the pop bubble, and wherein each dice comprises six faces with each face identified by a unique number from a range of 1-6.
